(19) United States
(12) Patent Application Publication
(10) Pub. No.: US 2006/0154769 A1
(43) Pub. Date: Jul. 13, 2006

(54) Extensible belt presenting a polyamide 6.6 cord, in particular for an automotive application

(76) Inventors: Julie Rognon, St Cyr Sur Loire (FR); Herve Varin, Joue Les Tours (FR)

Correspondence Address: CLARK & BRODY, 1090 VERMONT AVENUE, NW, SUITE 250, WASHINGTON, DC, 20005, US

(21) Appl. No.: 11/295,631

(22) Filed: Dec. 7, 2005

(30) Foreign Application Priority Data
Dec. 8, 2004 (FR) 0413057

(51) Int. Cl. F16G 5/00

(52) U.S. Cl. 474/237

(57) ABSTRACT

The invention relates to an extensible V-ribbed belt 1 presenting a reinforcing structure 5 constituted by a polyamide 6.6 cord, the belt presenting a dynamic modulus at 120° C. and at 2 h lying in the range 7000 N/t/str/% to 10,000 N/t/str/%.

The present invention relates to an extensible V-ribbed belt presenting a polyamide 6.6 cord, for use in particular in motor vehicle applications.

### BACKGROUND OF THE INVENTION

The advantage of such belts also known as “snap-on” belts is that they can be put into place merely by being stretched. Unlike so-called “standard” belts, after being put into place they are capable of retaining sufficient working tension to avoid any need for the presence of a stationary tensioner.

Extensible belts with a polyamide 6.6 cord are already used for transmitting power in electrical household appliances such as washing machines, where the driven power (≦1 kilowatts (kW)) and the acyclism are small.

Such belts present a dynamic modulus that is low, thus making them incompatible with automotive applications, where powers are higher and where acyclism phenomena are encountered, which phenomena are particularly severe with diesel engines.

The low dynamic modulus is due to the fact that polyamide 6.6 presents performance that is less good than the polyamide 4.6 that is used for making the cords of extensible belts for automotive applications.

However, polyamide 6.6 (PA 66) is less expensive than polyamide 4.6 (PA 46). It would therefore be desirable to have an extensible belt available using polyamide 6.6 and suitable for automotive applications, with properties that come as close as possible to the performance of PA 46.

Automotive belts with a polyamide 6.6 cord are already available on the market, but they present a dynamic modulus that is well below that of belts having a polyamide 4.6 cord, as is demonstrated by the comparative example below in the present description.

Furthermore, those belts present the feature of hot extra tension ST that is negative, which is unfavorable, since for the great majority of its operating time the belt is operating hot, and thus with tension that is lower than its nominal tension when at rest.

The idea on which the invention is based is to make an extensible belt from a polyamide 6.6 cord that is improved by modifying its thread-manufacturing parameters.

### OBJECTS AND SUMMARY OF THE INVENTION

The invention thus provides a V-ribbed extensible belt presenting a reinforcing structure constituted by a polyamide 6.6 cord, the belt presenting a dynamic modulus M₂ after 2 hours (h) at 120° C. that lies in the range 7000 newtons per tooth per strand per percentage elongation (N/t/str/%) to 10,000 N/t/str/%, e.g. greater than 7200 N/t/str/%.

The dynamic modulus M₂₄ at 24 h advantageously lies in the range 8000 N/t/str/% to 11,000 N/t/str/%, and more particularly in the range 8000 N/t/str/% to 10,000 N/t/str/% (or indeed in the range 8000 N/t/str/% to 9500 N/t/str/%). In position, it can be greater than 8500 N/t/str/%.

The belt advantageously presents extra tension ST that is positive as measured under conditions defined below. By way of non-limiting example, this extra tension ST is equal to not less than 5% and in particular lies in the range 5% to 20%.

The belt advantageously presents tension relief DT measured under the conditions defined below, that is greater than −25%, and in particular lies in the range −25% to −10%.

The conventional methods of manufacturing a thread for cords generally implements two successive stretching steps.

In the invention, the cord can be made of a polyamide 6.6 thread having a diameter lying in the range 0.9 millimeters (mm) to 1.2 mm, for example, as obtained by a method that includes at least one step of stretching the cord to a tension lying in the range 100 millinewtons per decitex (mN/dtex) to 160 mN/dtex and at a temperature lying in the range 180° C. to 220° C., and more particularly in the range 180° C. to 200° C.

### BRIEF DESCRIPTION OF THE DRAWINGS

The invention will be better understood on reading the following description with reference to the accompanying drawings, in which:

FIG. 1 is a section view through a belt of the invention; and

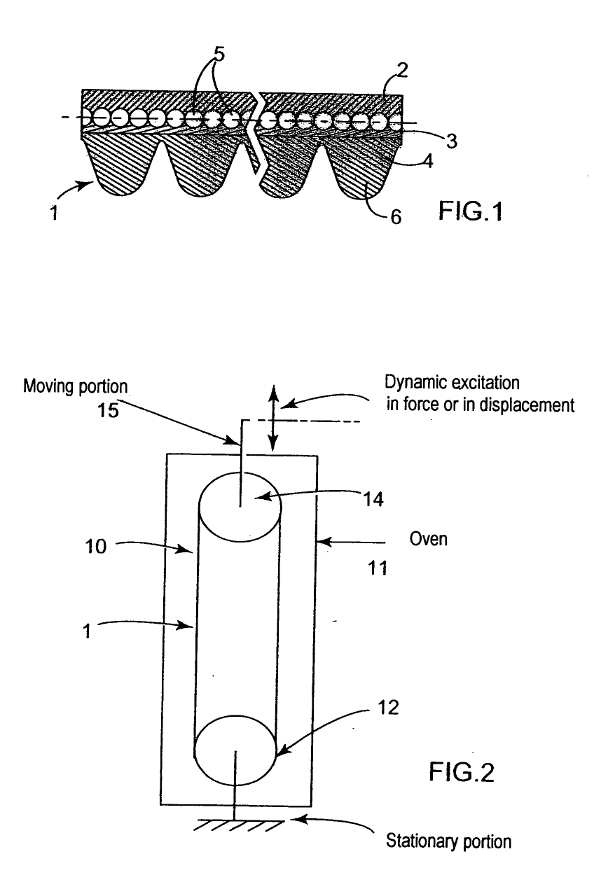

FIGS. 2 and 3 show how dynamic modulus, extra tension, and tension relief are measured.

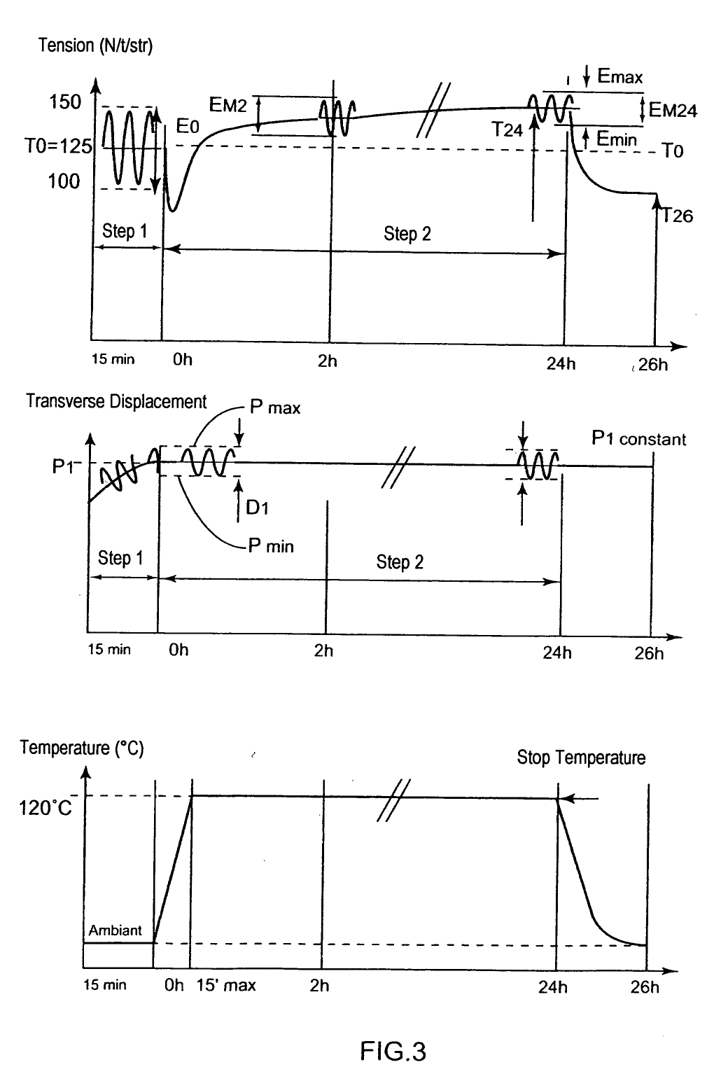

### MORE DETAILED DESCRIPTION

A belt 1 of type K conventionally presents an outer layer 2 of elastomer, a cushion layer 3 of elastomer, and an inner layer 4 of elastomer presenting V-ribs 6 at a standardized pitch p of 3.56 mm. Reference 5 designates the reinforcing cord constituted by a braided thread of diameter d which is wound helically at a pitch p. This winding is performed from edge to edge, possibly together with spacing.

The cord 5 is obtained from a thread of polyamide 6.6. The dynamic properties of the cord are increased by stretching and thermal fixing during its manufacturing process.

During the process of manufacturing the cord, at least one step of stretching the cord, e.g. a 940×2×3 cord, is implemented at high temperature and at high stretching tension, with temperature lying in the range 180° C. to 220° C. and more particularly in the range 180° C. to 200° C., and with stretching tension lying in the range 100 mN/dtex to 160 mN/dtex.

For a polyamide 6.6 cord, e.g. of the same type as is already in use for “adapted modulus” extensible belts for washing machines, a considerable increase is obtained in the dynamic modulus of the belt, with a dynamic modulus at 120° C. and at 2 h that is greater than 7000 N/t/str/% and at 24 h that is greater than 7700 N/t/str/%, to be compared with a value of 3000 N/t/str/% for a similar belt made using a prior art polyamide 6.6 cord.

The dynamic modulus at 120° C. is measured by a hot dynamic relaxation test on an extensometer bench such as an Instron dynamic pulser 10 presenting two pulleys 12 and 14, one of which is stationary and the other of which is movable. The Instron dynamic bench serves to apply excitation to the moving portion (cross-member 15) connected to the pulley 14, which excitation is dynamic, either in terms of force or in terms of displacement. The belt 1 and the bench 10 are contained in an oven 11 enabling temperature to be varied.

This dynamic test performed while hot is continued for at least 2 h, however it is advantageously prolonged up to 24 h so that the belt becomes completely stabilized, thus enabling a dynamic modulus to be determined that is more pertinent for characterizing the operation of a belt than is a conventional static test, e.g. implemented using the first elongation force curve or the fifth elongation force curve.

Test Procedure

1) An initial strand tension T₀ of 125 newtons per tooth per strand (N/t/str) is applied for 15 minutes (min) at ambient temperature (20° C.±5° C.), which tension is modulated by a dynamic tension varying sinusoidally at a frequency of 37 hertz (Hz) with a peak-to-peak amplitude E₀ of 50 N/t/str. After 15 min and before interrupting the dynamic force, the mean position P1 of the cross-member of the dynamic bench is observed, i.e. half the sum the maximum and minimum positions Pmax and Pmin of the cross-member due to said dynamic tension at instant t=15 min, together with the dynamic displacement amplitude D1 of the cross-member (peak-to-peak amplitude D1) which is generated at instant t=15 min by the dynamic tension of ±25 N/t/str (amplitude E₀ of 50 N/t/str).

The elongation percentage D2 of the belt corresponding to the dynamic displacement amplitude D1 of the cross-member has the value:
D2=2(D1/L)×100
where L designates the effective length of the belt.

2) At the end of step 1 which serves to stabilize the belt, the cross-member is put into above-defined position P1 and the above-defined dynamic displacement amplitude D1 is applied to the cross-member. The temperature of the bench is caused to rise from the beginning of step 2. It lasts for a maximum of 15 min.

The dynamic test is continued for 24 h at 120° C. The amplitude of the dynamic tension E_{Mt} in one strand is observed at one or more instants t, where said amplitude is the difference between the maximum dynamic tension Eₘₐₓ and the minimum dynamic tension Eₘᵢₙ. E_{Mt} is used for calculating the dynamic modulus.

The dynamic modulus M at instant t is deduced from the ratio of E_{Mt} expressed in N/t/str and D2 expressed in % elongation, where the dynamic modulus is expressed in N/t/str/% elongation, i.e. M=E_{Mt}/D2.

The dynamic modulus M₂ is determined at time t=2 h and is the modulus M₂₄ at time t=24 h on the basis of the dynamic amplitudes in tension at 2 h and at 24 h written respectively E_{M2} and E_{M24}.

3) The extra tension characteristics ST and the tension relief characteristics DT of the belt are also determined during the test.

The mean dynamic tension T₂₄ of a strand of the belt is measured (in N/t/str) and t=24 h (at 120° C. Specifically:
T₂₄=(Eₘₐₓ+Eₘᵢₙ)/2

The extra tension ST expressed in % has the following value:
ST=100(T₂₄−T₀)/T₀

4) The belt is allowed to cool for 2 h while static with the cross-member being held in the position P1 (step 3) and the tension T₂₆ in a strand is measured (in N/t/str) at time t=26 h.

The tension relief DT (in N/t/str) is given by:
DT=100(T₂₆−T₀)/T₀

In general, ST is a positive number while DT is always a negative number.

A belt of the invention presents an extra tension ST that is positive while its tension relief DT is greater than −25% (e.g. it is equal to −20% C).

### EXAMPLE I

A K6 type belt having a length L=1200 mm presenting a 940×2×3 cord of polyamide 6.6 (PA 66) having a diameter of 1 mm that had been subjected to two stretching steps in the range 100 mN/dtex to 160 mN/dtex at a temperature lying in the range 180° C. to 200° C. was subjected to the above-defined test. It is recalled here that the amplitude E₀ (step 1) is 50 N/t/str.

The data observed was as follows:

| Amplitude of | | | | | |
|---|---|---|---|---|---|
| transverse | | Dynamic | | | Tension at |
| dynamic | | amplitude | | | ambient |
| displacement | | of tension in one | | Mean hot | temperature |
| D1 (end of | Amplitude of | strand | | tension | at 26 h |
| step 1 and | belt | E_{M2} at | E_{M24} at | at 24 h | (TM) |
| retained in | displacement | 2 h | 24 h | (N/t/str) | (N/t/str) |
| step 2) (mm) | D2 (%) | (N/t/str) | (N/t/str) | T₂₄ | T₂₆ |
| 2.247 | 0.374 | 27.2 | 33.4 | 137.5 | 100 |

It is recalled that the tension in N/t/str is equal to the force on the cross-member divided by the number of teeth and divided by 2 (because there are two strands between two same-diameter pulleys).

For a K6 belt T₀=125 N/t/str=1500 N (crossbar force)/6 (number of teeth) and /2 strands.

The hot dynamic modulus at instant t, Mₜ=EMₜ/D2, where EMₜ designates the amplitude of the dynamic tension in one strand in N/t/str and D2 represents the dynamic elongation of the belt in %.

In the example of the above table, this gives:

E_{M2}=27.2 N/t/str; E_{M24}=33.4 N/t/str

D1=2.247 mm

L=1200 mm

D₂=2D1/L×100=200×2.247/1200=0.374%

M₂=E_{M2}/D2=27.2/0.374=7270 in N/t/str/%

M₂₄=E_{M24}/D2=33.4/0.374=8930 in N/t/str/%

Extra tension when hot ST(%)=100(T₂₄−T₀)/T₀ with

T₀=125 N/t/str and T₂₄=137.5 N/t/str

ST=100 (137.5−125)/125=10%

Variation in tension in a strand at ambient tension or tension relief

DT(%)=100(T₂₆−T₀)/T₀ with

T₀=125 N/t/str and T₂₅=100 N/t/str

DT=100×(100−125)/125=−20%

### COMPARATIVE EXAMPLE

| | | | Extra | Tension |
|---|---|---|---|---|
| | | | tension ST | relief DT at |
| | Dynamic modulus | | when hot | ambient |
| | when hot | | (120° C.) | temperature |
| | M₂ at 2 h | M₂₄ at 24 h | after 24 h | after 26 h |
| | (N/t/str/%) | (N/t/str/%) | (%) | (%) |
| Automotive | 7250 | 9330 | 20 | −7 |
| belt with | | | | |
| cord in | | | | |
| PA 4.6 | | | | |
| Belt of | 7270 | 8930 | 10 | −20 |
| Example I | | | | |
| with cord in | | | | |
| PA 6.6 | | | | |
| Automotive | 6380 | 7730 | −8 | −30 |
| belt with | | | | |
| cord in PA | | | | |
| 6.6 | | | | |

1. An extensible V-ribbed belt presenting a reinforcing structure constituted by a polyamide 6.6 cord, the belt presenting a dynamic modulus M₂ at 120° C. and at 2 h lying in the range 7000 N/t/str/% to 10,000 N/t/str/%.

2. A belt according to claim 1, wherein said dynamic modulus at 2 h M₂ is greater than 7200 N/t/str/%.

3. A belt according to claim 1, presenting a dynamic modulus at 24 h M₂₄ lying in the range 8000 N/t/str/% to 11,000 N/t/str/%, and in particular in the range 8000 N/t/str/% to 10,000 N/t/str/%.

4. A belt according to claim 3, wherein the dynamic modulus at 24 h M₂₄ lies in the range 8000 N/t/str/% to 9500 N/t/str/%.

5. A belt according to claim 3, wherein the dynamic modulus M₂₄ is greater than 8500 N/t/str/%.

6. A belt according to claim 1, presenting extra tension ST that is positive.

7. A belt according to claim 1, presenting tension relief DT that is greater than −25% and in particular lies in the range −25% to −10%.

8. A belt according to claim 1, wherein the cord is made of a polyamide 6.6 thread obtained in a method in which there exists at least one step of stretching the cord at a tension lying in the range 100 mN/dtex to 160 mN/dtex, and a temperature lying in the range 180° C. to 220° C.

9. A belt according to claim 1, wherein the cord presents a diameter lying in the range 0.9 mm to 1.2 mm.

10. A belt according to claim 4, wherein the dynamic modulus M₂₄ is greater than 8500 N/t/str/%.
